(19) United States
(12) Patent Application Publication
(10) Pub. No.: US 2024/0191121 A1
(43) Pub. Date: Jun. 13, 2024

(54) THERMAL ENERGY MEDIA WITH HIGH DURABILITY AND HIGH SOLAR ABSORPTIVITY AT HIGH TEMPERATURES

(71) Applicant: Advanced Materials Scientia LLC, Bothell, WA (US)

(72) Inventors: Kyu Bum HAN, Bothell, WA (US); Eunjin JEON, Bothell, WA (US)

(21) Appl. No.: 18/531,541

(22) Filed: Dec. 6, 2023

Related U.S. Application Data
(60) Provisional application No. 63/430,755, filed on Dec. 7, 2022.

(51) Int. Cl. C09K 5/14; C04B 35/628; F24S 70/16; F24S 70/20

(52) U.S. Cl. CPC C09K 5/14; C04B 35/62813; C04B 35/62886; F24S 70/16; F24S 70/20; C04B 2235/3222; C04B 2235/3274; C04B 2235/763; C04B 2235/77; C04B 2235/95

(57) ABSTRACT

Particles for multifunctional thermal energy media of the present invention are a sand-based material and economical material with a high thermal storage capability, and iron oxides and aluminum oxide are added to the sand to retain high solar absorptivity at high temperatures.

### CROSS-REFERENCE TO RELATED APPLICATION

This application claims the benefit under 35 USC § 119 of U.S. Provisional Patent Application Ser. No. 63/430,755 filed in the U.S. Patent and Trademark Office on Dec. 7, 2022, the entire contents of which are hereby incorporated herein by reference.

### TECHNICAL FIELD

The present invention relates to novel and economical thermal transfer media for concentrating solar power (CSP) systems with high durability and high solar absorptivity at high temperatures.

### BACKGROUND ART

Globally, the demand for renewable energy significantly increases to suppress carbon dioxide emissions. The electricity generation by solar power is becoming the mainstream among renewable energy sources. Accordingly, many countries are investing in installing energy transfer and storage for solar power generation. Particularly, concentrating solar power (CSP) systems generating solar power by using mirrors or lenses to concentrate a large area of sunlight onto a receiver are excellent examples that need energy transfer and storage simultaneously. Electricity is generated when the concentrated sunlight is converted to heat (solar thermal energy), which drives a heat engine or a steam turbine connected to an electrical power generator or powers a thermochemical reaction. The CSP system has a high lifespan and efficient power generation. Since the CSP system has energy store capability, it has the advantage of generating electricity even after sunset.

There is an increasing carbon emission in the environment and is one of the prime anthropogenic causes of climate change. The burning of fossil fuels such as oil, coal and gas or cutting down and burning of trees is the main cause of carbon emission. To overcome the problem, the solar power generation has been developed to generate less expensive energy than fossil fuels. Additionally, the advanced thermal energy storage (TES) will lower the energy prices more because the TES system allows industry to use the collected energy directly by industrial process heat (IPH). Consequently, developing the advanced TES technology will reduce carbon dioxide.

The CSP is a highly capital-intensive technology for cost-effective and environmentally friendly energy. As a result, the expansion of the CSP market is driven by rising energy demand and government support for renewable technology adoption. In addition, the market growth is accelerating as awareness of environmental pollution caused by existing power plants increase and concerns about global warming increase. The current major challenge is that CSP requires expensive components and precise engineering products. The problem causes a high value of the Levelized Cost of Energy (LCOE). It is critical to reduce the component cost while improving the performance.

The third generation concentrating solar power (Gen3 CSP) is the particle-based system. The solid particle system is preferred as increasing the operation temperature, so the system provides more energy efficiency. The desirable operation temperature for Gen3 CPS is equal or above 1,000° C. (Mehos et al., 2017).

The concentrated sunlight from a heliostat is collected in a tower. While a large amount of the particles is falling in the tower, the particles directly absorb the thermal energy from the concentrated sunlight. The heated particles are transferred to and stored in thermal energy storage (TES) tanks and used to heat secondary working fluids (e.g., steam, CO₂, air) for power cycles. The particles are an important component in reducing the levelized cost of electricity (LCOE).

Lowering the particle price by 95% from $1/kg to $0.05/kg leads to about a 15.5% reduction in LCOE (Kevin Albrecht et al., 2019). Among the components in the CSP system, particle cost has a higher potential to realize reductions in fixed capital costs because other components are relatively mature (e.g., turbo machinery).

Various particles have been investigated for Gen3 CSP. In particular, sintered bauxite proppant is widely used in academic research and industry. The proppant is thermally stable and exhibits high solar absorption at high temperatures (Calderón et al., 2021, 2019; Siegel et al., 2014). However, the high cost of particles (>1 $/kg) is a major problem (Mehos et al., 2017).

The Department of Energy seeks a solution the improve the thermal transfer fluid for particle-based concentrating solar power (CSP) system. While ceramic proppants have been widely used for thermal transfer media, their high cost (>$1,000/ton) is a significant hurdle for further reduction of the levelized cost of energy (LCOE). If the invented media or particles show excellent solar absorptivity and storage capabilities at a low price, the media can be used in both thermal energy transfer vehicles and storage, which creates a significant reduction of LCOE.

Accordingly, the present inventors have made extensive efforts to develop a thermal transfer media for particle-based concentrating solar power (CSP) system, and as a result, have found that, when the particles involved creating a core of silica sand with a coating layer composed of iron oxides and aluminum oxide are applied to a conduit for thermal energy storage and conveyance, they show excellent solar absorptivity and storage capabilities at a low price and the media can be used in both thermal energy transfer vehicles and storage, which creates a significant reduction of LCOE, thereby completing the present invention.

### PRIOR ART DOCUMENTS

### Non-Patent Documents

Calderón, A., Barreneche, C., Fernández, A. I., Segarra, M., 2021. Thermal cycling test of solid particles to be used in concentrating solar power plants. Sol. Energy Mater. Sol. Cells 222, 110936.
Calderón, A., Barreneche, C., Palacios, A., Segarra, M., Prieto, C., Rodriguez-Sanchez, A., Fernández, A., 2019. Review of solid particle materials for heat transfer fluid and thermal energy storage in solar thermal power plants. Energy Storage 1, e63.
ISO, I., 2006. Petroleum and natural gas industries—Completion fluids and materials—Part 2: Measurement of properties of proppants used in hydraulic fracturing and gravel-packing operations (Standard No. ISO 13503-2). International Organization for Standardization, Switzerland.
Kevin Albrecht, Matthew Bauer, Clifford Ho, 2019. Parametric Analysis of Particle CSP System Performance and Cost to Intrinsic Particle Properties and Operating Conditions, in: Proceedings of the ASME 2019. Presented at the 13th International Conference on Energy and Sustainability, ASME, Bellevue, WA.
Mehos, M., Turchi, C., Vidal, J., Wagner, M., Ma, Z., Ho, C., Kolb, W., Andraka, C., Kruizenga, A., 2017. Concentrating Solar Power Gen3 Demonstration Roadmap (No. NREL/TP-5500-67464). National Renewable Energy Lab, Golden, CO.
Siegel, N., Gross, M., Ho, C., Phan, T., Yuan, J., 2014. Physical Properties of Solid Particle Thermal Energy Storage Media for Concentrating Solar Power Applications. Energy Procedia, Proceedings of the SolarPACES 2013 International Conference 49, 1015-1023.

### SUMMARY OF THE INVENTION

The present invention has been made in view of the above-described problems, and it is an object of the present invention to provide thermal transfer media for thermal energy storage and conveyance which exhibits excellent solar absorptivity and storage capabilities at a low price and can be used in both thermal energy transfer vehicles and storage, thereby creating a significant reduction of LCOE, and a preparation method thereof.

To achieve the above object, the present invention provides a thermal transfer media for concentrating solar power (CSP) system, comprising: (a) a core of silica sand; and (b) a coating layer composed of iron oxide and aluminum oxide coated on the core.

Also, the present invention provides a method of preparing the thermal transfer media for concentrating solar power (CSP) system, which comprises: (a) preparing a slurry by mixing silica sand and a dispersion liquid containing iron oxide and aluminum oxide; (b) preparing coated particles by post-mixing the slurry; and (c) sintering the particles under a forming gas environment with hydrogen at 300 to 500° C. and under argon gas environment at temperature of 900 to 1400° C., thereby inducing the formation of a hercynite structure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows images of (A) silica sand without coating, (B) iron oxides-aluminum oxide coated silica sand reduced at 400° C. for 3 hours in forming gas, and iron oxides-aluminum oxide coated silica sand sintered at 900° C. in (C) argon gas (D) 5% hydrogen-95% argon and (E) air for 2 hours after reduction.

FIG. 2 is a graph showing bulk and true densities of (A) silica sand without coating, (B) iron oxides-aluminum oxide coated silica sand reduced at 400° C. for 3 hours in forming gas, and iron oxides-aluminum oxide coated silica sand sintered at 900° C. in (C) argon gas (D) hydrogen and (E) air for 2 hours after reduction.

FIG. 3 shows iron oxides-aluminum oxide coated silica sand sintered at (a) 900° C.; (b) 1050° C.; (c) 1100° C.; (d) 1200° C.; (e) 1300° C.; and (f) 1400° C. in argon gas after reduction at 400° C. for 3 hours in forming gas.

FIG. 4 shows data for crush resistance increase of iron oxides-aluminum oxide coated silica sand sintered at from 400° C. to 1050° C. in argon gas after reduction at 400° C. for 3 hours in forming gas.

FIG. 5 shows data for absorptivity of (a) iron oxides and (b) iron oxides-aluminum oxide coated silica sand before and after thermal aging test at 800° C. in air.

FIG. 6 shows X-ray diffraction data of (a) iron oxides and (b) iron oxides-aluminum oxide coated silica sand before and after thermal aging test at 800° C. in air.

FIG. 7 shows data for particle size distribution and particle image (inside) of iron oxides-aluminum oxide coated silica sand.

### DETAILED DESCRIPTION OF THE INVENTION

Unless defined otherwise, all technical and scientific terms used herein have the same meanings as appreciated by those skilled in the field to which the present invention pertains. In general, the nomenclature used herein is well-known in the art and is ordinarily used.

The present invention presents novel and economical thermal transfer media for concentrating solar power (CSP) systems with high durability and high solar absorptivity at high temperatures which comprises a core of silica sand with a coating layer composed of iron oxides and aluminum oxide and can be applied to a conduit for thermal energy storage and conveyance. It has been confirmed that the particles show excellent solar absorptivity and storage capabilities at a low price and can be used in both thermal energy transfer vehicles and storage, which creates a significant reduction of LCOE.

Therefore, an aspect of the present invention is directed to a thermal transfer media for a concentrating solar power (CSP) system, comprising: (a) a core of silica sand; and (b) a coating layer composed of iron oxide and aluminum oxide coated on the core.

Another aspect of the present invention is also directed to a method of preparing a thermal transfer media for a concentrating solar power (CSP) system, which comprises: (a) preparing a slurry by mixing silica sand and a dispersion liquid containing iron oxide and aluminum oxide; (b) preparing coated particles by post-mixing the slurry; and (c) sintering the particles under a forming gas environment with hydrogen at 300 to 500° C. and under argon gas environment at temperature of 900 to 1400° C., thereby inducing the formation of a hercynite structure.

The third-generation concentrated solar power (Gen3 CSP) systems represent the zenith of current CSP technology, focusing on heightened efficiency, cost reduction, and improved performance in solar energy generation. These systems stand at the forefront of the rapidly evolving renewable energy sector, capitalizing on novel designs, state-of-the-art materials, and sophisticated components to push the boundaries of solar-to-electric conversion efficiencies and thermal energy storage. Gen3 CSP technologies aim to curtail the environmental footprint of solar energy production while offering scalable and modular configurations suitable for diverse applications and geographic locales.

Gen3 CSP systems distinguish themselves from previous iterations by offering several advantages. They incorporate advanced designs and materials to enhance solar-to-electric conversion efficiency, thereby optimizing the use of solar resources and increasing electricity generation. They are also designed to minimize the costs associated with solar power, making CSP a more competitive renewable energy source. These systems include efficient thermal energy storage (TES) solutions that allow for on-demand energy delivery, contributing to a more reliable and flexible electricity supply. Additionally, they employ environmentally responsible practices, such as reducing water usage and minimizing the use of hazardous materials.

However, Gen3 CSP systems also present challenges, primarily due to the complexity introduced by their advanced technologies, which can complicate manufacturing, installation, and maintenance, as well as potentially increase initial investment costs. Despite these challenges, Gen3 CSP has the capacity to address many of the limitations faced by earlier CSP generations, increasing energy efficiency and reducing costs, which may render them increasingly competitive for large-scale solar power generation.

In Gen3 CSP systems, particle technology is essential for achieving energy efficiency, effective heat transfer, energy storage, and cost-effectiveness. The choice of particle materials significantly impacts the overall system performance, and while certain materials like coal ash may be unsuitable due to their properties, ongoing research is directed towards finding particle solutions that balance performance with environmental and economic considerations.

The application serves as a conduit for thermal energy storage and conveyance. This versatile thermal transfer medium efficiently channels concentrated solar energy from the particle receiver to the storage system. In the storage, the medium facilitates the production of high-temperature energy, which is utilized to generate electricity via turbine engines. Due to the medium's advanced thermal properties and low cost, a significant reduction in the levelized cost of electricity (LCOE) to $0.059 per kWh or lower from $0.065 per kWh is anticipated. Beyond economic benefits, the technology supports the mission of achieving zero carbon emissions. The production process of the medium is straightforward, eliminating the need for energy-intensive methods like spray drying, and is expected to result in a 26% reduction in carbon emissions compared to traditional ceramic media production.

A thermal transfer media for concentrating solar power (CSP) systems may comprise (a) a core of silica sand; and (b) a coating layer composed of iron oxide and aluminum oxide coated on the core.

In the present invention, the iron oxide may comprise 8 to 12 parts by weight and aluminum oxide may comprise 1 to 3 parts by weight based on 1000 parts by weight of the silica sand.

In the present invention, the iron oxide can be Fe₂O₃ and the coating layer may have a hercynite structure represented by the formula of AlFe₂O₃. The silica sand coated with iron oxide and aluminum oxide demonstrated 100% conversion to hercynite (AlFe₂O₃).

In the present invention, the median particle size was recorded at 480 μm with circularity distributions ranging from 0.82 to 0.88.

The particle size may be 100 to 1000 μm, preferably 100 to 900 μm, and more preferably 200 to 700 μm. Particle sizes below 100 micrometers (μm) and above 1000 micrometers (μm) may lead to a non-uniform flow rate during their free fall within the receiver tower of the CSP system. Such disparities in flow rates can often be attributed to external environmental factors, notably wind, which can alter particle trajectory and velocity.

Further considerations for particles outside the optimal size range include:

### For Particles Smaller Than 100 μm:

1. Erosion: Small particles, due to their high surface-to-volume ratio at accelerated flow velocities, may cause heightened erosion of pipes, pumps, and other system components.

2. Fluidization Challenges: While such particles may fluidize readily, excessive aeration can lead to defluidization, where particles are entrained by the flow, thus decreasing material retention and system efficiency.

3. Thermal Energy Retention: Their significant surface area may result in rapid heat dissipation, particularly if not insulated adequately or during atmospheric exposure.

4. Dust Generation: The creation of fine dust poses health risks, contributes to equipment fouling, and can lead to material loss.

5. Agglomeration: The propensity of fine particles to clump together may result in inconsistent flow and potential clogging, disrupting heat distribution.

6. Segregation: Smaller particles may segregate from a mixed-size ensemble, causing uneven distribution in storage or receiver systems and affecting thermal transfer.

7. Flow Control: The control over the flow of such particles is complex due to their slow settling characteristics and susceptibility to air currents.

8. Filtration Necessities: High-grade filtration systems are needed to contain fine particles, adding system complexity and cost.

9. Material Loss: Small particles are at higher risk of being lost due to environmental factors like wind.

10. Thermal Storage: Their ability to retain heat may be compromised in thermal storage applications due to increased surface area.

11. Measurement and Feeding: Precision in the measurement and consistent feeding of fine particles into the system may require sophisticated control systems.

### For Particles Larger Than 1000 μm:

1. Heat Exchange Rate: Larger particles possess a reduced surface area relative to volume, diminishing the heat exchange rate due to decreased surface contact.

2. Heat Transfer Efficiency: The reduced surface area-to-volume ratio can result in slower thermal response times, leading to diminished heat transfer efficiency.

3. Fluidization Inefficiency: Larger particles may not fluidize as effectively, potentially leading to uneven heat distribution within the system.

4. Sedimentation: There is an increased tendency for larger particles to settle, which can lead to sedimentation and blockages.

5. Material Handling: Larger particles necessitate more robust handling and conveyance systems, potentially increasing system costs.

6. Equipment Wear: The mass and size of larger particles can result in greater wear and abrasion on system components.

7. Flow Consistency: Achieving a consistent flow can be challenging due to potential jamming or bridging in feeding mechanisms.

8. Homogeneity: Maintaining a homogeneous mixture for heat distribution may be more difficult with larger particles.

9. Thermal Storage Packing: The efficiency of thermal storage packing can be reduced, potentially necessitating larger storage capacities.

10. Thermochemical Reactivity: Larger particles may exhibit reduced reactivity in systems that rely on thermochemical storage.

11. Transportation: Conveyance systems may encounter difficulties in transporting larger particles, affecting energy consumption and transport efficiency.

Optimizing particle size within the prescribed range is vital for ensuring the functional integrity and efficiency of Gen3 CSP systems.

In the present invention, the bulk density of the of the thermal transfer media can be 0.5 to 2.5 g/cm³, preferably 0.8 to 2.0 g/cm³, more preferably 1.0 to 1.7 g/cm³, and most preferably 1.4 to 1.6 g/cm³.

In the present invention, the true density of the of the thermal transfer media can be 1.5 to 4.0 g/cm³, preferably 2.0 to 3.5 g/cm³, more preferably 2.5 to 3.0 g/cm³, most preferably 2.5 to 2.8 g/cm³.

Within the domain of third-generation concentrated solar power (CSP) systems, the parameters of bulk and true densities are essential determinants of the particles' flow dynamics utilized for heat transfer or energy storage. These properties critically influence the system's operational efficiency and stability.

It is advised to avoid bulk densities below 0.5 grams per cubic centimeter (g/cm³) or above 2.5 g/cm³ for several reasons:

1. Flowability: Bulk density serves as a measure of flowability. Particles with lower bulk density tend to have more interstitial space, facilitating easier movement through conveyance systems. Conversely, a higher bulk density may indicate reduced void space, potentially increasing frictional forces and causing flow obstructions such as arching or rat-holing.

2. Feeder Design: Feeder systems, integral for modulating particle flow rates into the CSP system, must be designed with consideration for bulk density. Configurations for feeders may vary significantly with density; lower densities might demand specialized designs for uniform flow, whereas higher densities could necessitate stronger, more capable handling equipment.

3. Energy Consumption: The energy required to convey particles is directly correlated with bulk density; particles of higher bulk density consume more energy during transport, which can negatively affect the CSP system's energy efficiency.

4. Heat Transfer and Storage: Bulk density directly influences the thermal mass within a given volume, affecting the heat exchange rate with the particles. A greater bulk density implies an increased material quantity for absorbing or dissipating heat, which could modify the necessary flow rate to reach a particular thermal output.

5. System Capacity: The amount of particle mass that can be held in a specified volume is determined by bulk density, impacting the design and capacity of the storage and heat transfer infrastructure.

6. Pressure Drop: In pneumatic conveyance within the CSP system, the bulk density of particles influences the pressure gradient, with a higher bulk density likely causing a greater pressure drop, thus requiring stronger fans or pumps to sustain the desired flow rate.

7. Segregation and Mixing: Utilization of particles with varying bulk densities can result in segregation due to differential settling rates during flow, potentially causing inconsistent heating if the particles act as heat carriers and possibly necessitating flow rate adjustments for uniform temperature distribution.

8. Erosion and Wear: Particles with a higher bulk density can induce more significant erosion and wear on system components due to increased mass during motion, potentially necessitating a reduced flow rate to mitigate equipment damage.

Similarly, the true densities below 1.5 g/cm³ or above 4.0 g/cm³ are not recommended due to the following:

1. Heat Transfer Efficiency: Particles with a greater true density typically have a higher heat capacity, enabling them to store and retain more thermal energy. This can lead to improved energy transfer efficiency within CSP systems, as these denser particles may maintain heat longer, reducing the frequency of reheating and stabilizing the flow rate to uphold the desired temperature gradient.

2. Flow Dynamics in Receiver: The true density of particles influences their terminal velocity within the receiver tower. Particles with a higher true density descend more swiftly and are less susceptible to disturbances from updrafts or lateral winds, ensuring a more consistent and controlled flow critical for maintaining the optimal particle concentration in the heat exchange zone.

3. System Design and Particle Transport: The design of pneumatic systems, hoppers, and other particle transport mechanisms within a CSP system is often predicated on the true density of the particles. Particles with a higher density may require more robust equipment for effective movement, affecting the flow rate, while those with a lower density could be more prone to clogging or irregular flow, necessitating meticulous design for continuous operation.

4. Fluidization and Energy Losses: True density determines the energy expenditure necessary to fluidize particles for heat transfer processes. Particles with a lower true density may achieve fluidization with less energy, potentially decreasing the flow rate maintenance energy requirements, in contrast to denser particles that will demand more energy, impacting overall system efficiency.

5. Thermal Conductivity: Although not a direct determinant of flow rate, true density is frequently associated with thermal conductivity. Particles with a higher density are generally more thermally conductive, which can enhance heat transfer within the CSP system and indirectly affect flow rate by altering the thermal gradient that propels particle movement.

6. Erosion and Wear: Denser particles can increase erosion and wear on the equipment due to their augmented impact force, potentially necessitating reduced flow rates to curtail equipment degradation or requiring the incorporation of more resilient materials in construction, influencing the design and operational expenditure of the system.

The thermal transfer media for concentrating solar power (CSP) system can be prepared by a method comprising: (a) preparing a slurry by mixing silica sand and a dispersion liquid containing iron oxide and aluminum oxide; (b) preparing coated particles by post-mixing the slurry; and (c) sintering the particles under a forming gas environment with hydrogen at 300 to 500° C. and under argon gas environment at temperature of 900 to 1400° C., thereby inducing the formation of a hercynite structure (AlFe₂O₃).

In the present invention, in the step of (a), the silica sand can be prepared by performing acid-washing at pH 3-5.

In the present invention, in the step of (a), the dispersion liquid containing iron oxide and aluminum oxide can be prepared by dispersing in deionized water at pH 3-5 and ultrasonicating at room temperature for 5 to 15 minutes.

In one embodiment of the present invention, the production process for the particles involved creating a core of silica sand with a coating layer composed of iron oxides and aluminum oxide. A slurry was prepared in a cement mixer by combining silica sand, iron oxides, aluminum oxide, and deionized water at pH 3-5, which was mixed at room temperature for 1-3 days. Post-mixing, the slurry yielded fine particles.

In the present invention, a step of drying the slurry can be further performed after a step of (a).

In the present invention, the step of (b) can be performed at room temperature for 1 to 3 days with 20-50% of relative humidity.

In the present invention, the step of (c) can comprise:
(i) placing the coated particles in a furnace pre-purged with forming gas;
(ii) raising a temperature to at 300 to 500° C. at a rate of 8 to 12° C. per minute;
(iii) maintaining in a forming gas atmosphere with 5% hydrogen followed by a higher-temperature phase with a rate of 3 to 7° C. per minute in an argon atmosphere to prevent oxidation; and
(iv) cooling the furnace at a rate under argon at 3 to 7° C. per minute.

In the present invention, the temperature under argon gas environment may be 1050° C. The particles sintered at this temperature of 1050° C. are passed as qualified particles by satisfying the following criteria: aggregation of particles after sintering at high temperatures, particle darkness, particle color change after thermal aging performance in air at 800° C. and 1000° C. for 24 hours.

Hereinafter, although preferred embodiments will be described for better understanding of the present invention, it will be obvious to those skilled in the art that these embodiments are provided only for illustration of the present invention, and that a variety of modifications and alterations are possible without departing from the ideas and scope of the present invention and these modifications and alterations fall within the scope of claims of the present invention.

### EXAMPLES

### Example 1: Identification of Suitable Atmosphere Gas

The sintering process enhanced the mechanical strength. The process entailed two steps. The initial step aimed to enhance solar absorptivity by reduction at 400° C. for three hours in a forming gas environment with 5% hydrogen. This step proved crucial for improving the optical properties of the particles. The second step sintered at 900° C. for two hours under three different atmospheres—air, forming gas, and argon—to induce the formation of a hercynite structure, with each atmosphere contributing to the process in varying degrees, affecting the reduction of iron oxide and the control of the hercynite structure.

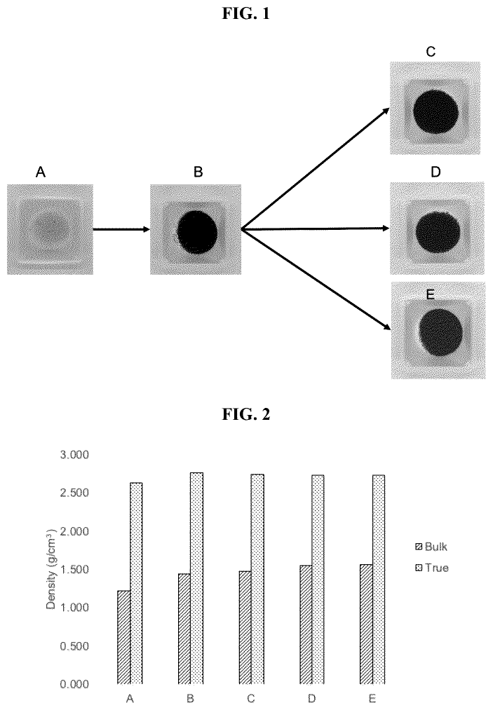

FIG. 1 shows images of the particles: (A) silica sand, (B) coated sand after reduction, and (C)-(E) reduced coated sands after sintering. In detail, the coated sands after reduction were sintered in three different atmospheres: (C) argon; (D) 5% hydrogen-95% argon; and (E) air. The sintered particles (C) in argon showed the darkest color compared to the rest of the particles (D) and (E). The particles (E) sintered in air demonstrated red color indicating the reduced iron oxides in Step 1 were oxidized by oxygen. In this visual observation, the particles in argon were selected for atmosphere gas during the sintering process.

### Example 2: Bulk and True Densities

Bulk density describes the mass of particles that fill a unit volume and includes both particles and porosity. It determines the particle's mass needed to fill a thermal energy storage tank. The true density excludes pores that can be in the particle as well as void spaces or pores between particles. The true density describes whether the iron oxide-aluminum oxide joins the silica sand. The bulk density was measured by referring to ISO 13503-2 (ISO, 2006). The true density was measured by a gas pycnometer.

The bulk and true densities are shown in FIG. 2 where A is silica sand, B is the iron oxide-aluminum oxide coated silica sands (or black particles (BPs)) reduced at 400° C., and the sintered BPs in air (C), 5% hydrogen (D), and argon (E). The detailed results are shown in Table 1. The densities were increased from silica sand to coated sands by 18%-20% in bulk density and 5% in true density. Compared to silica sand, the bulk density was increased by 3% when BPs were treated in the air. Compared to silica sand, the bulk density was increased by 8% when the BPs were treated in hydrogen and argon. When BPs were treated in diverse atmospheres, the true density was unchanged or slightly decreased by less than 1%. The increased true density after coating indicates that the iron oxide with aluminum oxide joined the silica sand. However, the thermal treatment in diverse atmospheres did not affect the true density or mass change. The bulk density, in contrast, was increased after thermal treatment. The results implied that thermal treatment would create pores on the particles.

TABLE 1
Summary of Bulk and True Densities (Mehos et al., 2017).

| Labels | Bulk Density (g/cm³) | True Density (g/cm³) |
|---|---|---|
| A | 1.220 | 2.637 |
| B | 1.442 | 2.767 |
| C | 1.2486 | 2.740 |
| D | 1.553 | 2.736 |
| E | 1.569 | 2.734 |

### Example 3: Synthesis Process

The coating process involved applying a layer of iron oxides and aluminum oxide to acid-washed silica sand particles. Specifically, 10% by weight of iron oxides and 2% by weight of aluminum oxide were used to coat the sand. The process began with washing 1 kg of sand with deionized water to achieve a pH of 3-5. Separately, iron oxides and aluminum oxide powders were dispersed in deionized water at the same pH, ultrasonicated for 10 minutes at room temperature, and then combined with the sand in a cement mixer. The mixing continued until the particles were fully dried and coated for 1-3 days at room temperature with 20%-50% of relative humidity.

For sintering, a measured amount of the coated particles was placed in a rotary furnace pre-purged with forming gas. The temperature was raised to 400° C. at 10° C. per minute and maintained in a forming gas atmosphere (5% hydrogen), followed by a higher-temperature phase with 5° C. per minute in an argon atmosphere to prevent oxidation. The furnace was then cooled down at a controlled rate under argon at 5° C. per minute.

### Example 4: Visual Observation

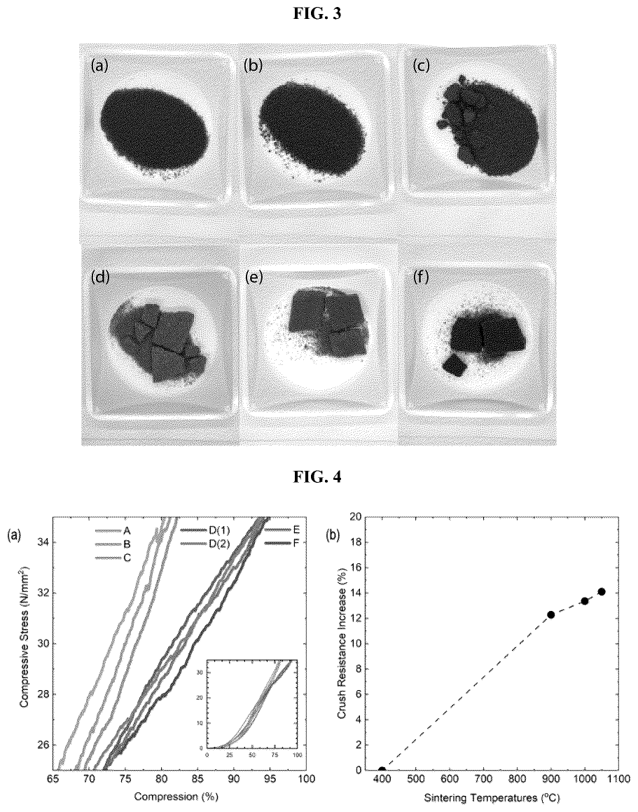

FIG. 3 illustrates the images of the particles sintered at diverse temperatures. Table 2 shows the recorded visual observation. The minimum temperature prompting particle aggregation was recorded at 1100° C. A notable observation was that as the temperature escalated, the aggregated particles demonstrated enhanced rigidity, making them more resistant to fragmentation. Table 2 summarized the qualified particles by satisfying the following criteria: aggregation of particles after sintering at high temperatures, particle darkness, particle color change after thermal aging performance in air at 800° C. and 1000° C. for 24 hours. The particles sintered at 1050° C. were passed all criteria. The particles were not aggregated, and the surface color was retained after thermal aging tests.

TABLE 2
Recorded Observation of Sintered Particles

| Sintering Temperatures | 900° C. | 1000° C. | 1050° C. | 1100° C. | 1200° C. | 1300° C. | 1400° C. |
|---|---|---|---|---|---|---|---|
| Aggregation | No | No | No | Yes | Yes | Yes | Yes |
| Particle Darkness | Yes | Yes | Yes | Yes | Yes | Yes | Yes |
| Particle Color Change | Yes | Yes | No | No | No | No | No |
| after Heating in Air at | | | | | | | |
| 800° C. for 24 Hours | | | | | | | |
| Particle Color Change | No | No | No | No | No | No | No |
| after Heating in Air at | | | | | | | |
| 1000° C. for 24 Hours | | | | | | | |

### Example 5: Crush Resistance

The BPs sintered at 400° C., 900° C., 1000° C., and 1050° C. in argon were tested for crush resistance in FIG. 4. The stainless-steel cell was utilized for the crush resistance test. The test procedure followed the ASTM (ASTM Standard, 2017. Standard Test Methods for Apparent Density, Bulk Factor, and Pourability of Plastic Materials). Table 3 describes the sintering temperatures. Samples from A to D were silica sand coated with aluminum oxide added iron oxides. Sample E was the sand with iron oxide without aluminum oxide coating, and Sample F was silica sand for control. The evaluation of crush resistance was meticulously carried out by quantifying the compressive stress, delineated as a function of percentage compression. The observations suggested a noteworthy correlation wherein lower levels of compression, for a fixed compressive stress, were indicative of superior crush resistance characteristics of the particles under consideration. FIG. 4 in part (a) shows the sample coated with aluminum oxide added iron oxides sintered at 1050° C. was the lowest compression in the same compressive stress at 35 N/mm². The sample without aluminum oxide added iron oxides coating exhibited the highest compression at 35 N/mm². As increasing the sintering temperature, the crush resistance was increased. For example, the particle sintered at 1050° C. demonstrated 14% greater than sintering temperature at 400° C. (FIG. 4 in part (b)).

TABLE 3
Sample Description for Crush Resistance

| Samples | Sintering Temperatures |
|---|---|
| A | 1050° C. |
| B | 1000° C. |
| C | 900° C. |
| D | 400° C. |
| E | 400° C. |
| F | NA |

### Example 6: Solar Absorptivity

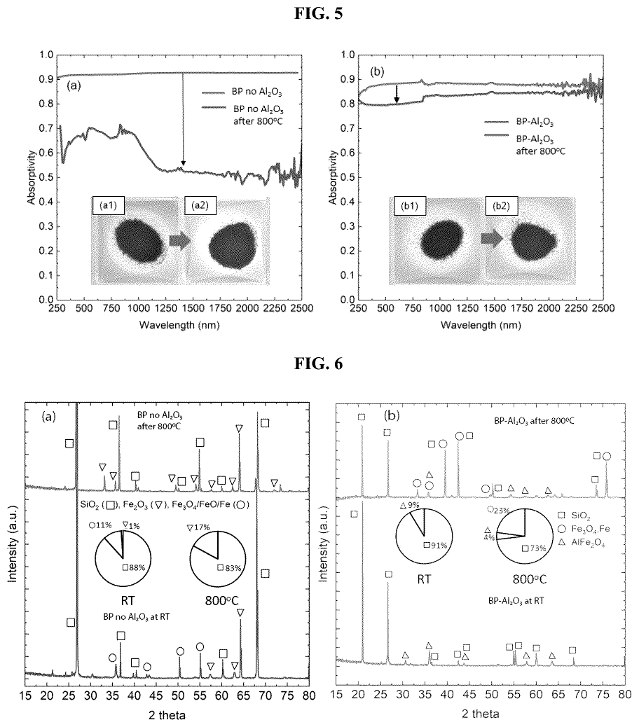

The BPs absorptivity was measured before and after thermal aging at a temperature of 800° C. The absorptivity of BPs without aluminum oxide shows in FIG. 5 in (a) therein. The images of BPs without aluminum oxide inside plot are before (FIG. 5 in (a1) therein) and after (FIG. 5 in (a2) therein) thermal aging. The particles became red color from dark gray after the aging. The red color indicates a lower absorptivity than gray and black colors due to oxidation from iron oxides. Concurrently, a notable decrease in absorptivity across the entire wavelength spectrum was observed. Specifically, the absorber efficiency plunged from an initial 0.912 to 0.647, marking a substantial reduction of 26.5%. Additionally, at wavelengths exceeding 1250 nm, the absorptivity was found to be comparatively lesser than at lower wavelengths.

The absorptivity of BPs without aluminum oxide shows in FIG. 5 in (b) therein. The images of BPs with aluminum oxide inside plot are before (FIG. 5 in (b1) therein) and after (FIG. 5 in (b2) therein) thermal aging. These particles remarkably preserved their black coloration even after thermal aging. A slight dip in absorptivity was detected for the Phase II particles following thermal aging. The absorber efficiency, which was initially at 0.886, declined to 0.824 post thermal aging. Furthermore, a marginal reduction in absorptivity was observed at lower wavelengths, ranging from 250 nm to 750 nm.

### Example 7: Crystal Structure

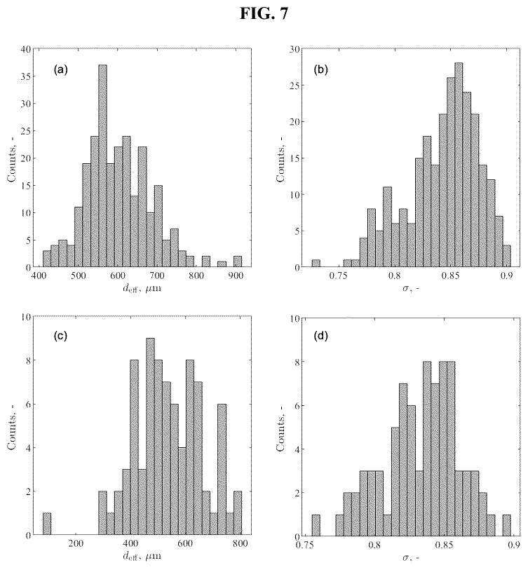

FIG. 6 displays the X-ray diffraction (XRD) data illustrating the alterations in crystal structure prior to and subsequent to thermal aging at 800° C. in air. The silica sand was coated with other types of iron oxides (other iron oxides) such as Fe₃O₄, FeO, and Fe⁰. However, there was a considerable increase in the iron oxides (Fe₂O₃) structure, from an initial weight percentage of 1% escalating to 17% following thermal aging. Notably, other iron oxides remained undetected throughout this process. Contrastingly, the silica sand coated with iron oxide and aluminum oxide demonstrated 100% conversion to hercynite (AlFe₂O₃). For example, the addition of coating to silica sand was ˜12 wt. %. The measured hercynite content was 9 wt. %. After thermal aging in air for 24 hours at 800° C., the hercynite content became 4 wt. % from 9 wt. %. Intriguingly, other iron oxide species manifested after the thermal aging process. One salient observation was the absence of iron oxides in the particles following the aging process, which has a plausible role in preserving the color and absorptivity properties consistent with those of the original particles.

### Example 8: Particle Size Distribution

Our characterization of silica sand particles focused on their size and circularity distributions as illustrated in FIG. 7 in graphs (a) and (b) therein. The median particle size was recorded at 480 μm with a circularity ranging from 0.82 to 0.88. The particles developed during Phase II, on the other hand, exhibited a median size distribution of 440 μm; however, multiple distributions were evident due to high count incidences, as shown in FIG. 7 in graph (c) therein. The circularity distribution of the BPs mirrored the range found in the silica sand particles used in the core, between 0.82 and 0.88, yet the circulation revealed dual distribution curves (FIG. 7 in graph (d) therein).

Although specific configurations of the present invention have been described in detail, those skilled in the art will appreciate that this description is provided to set forth preferred embodiments for illustrative purposes and should not be construed as limiting the scope of the present invention. Therefore, the substantial scope of the present invention is defined by the accompanying claims and equivalents thereto.

What is claimed is:

1. A thermal transfer media for a concentrating solar power (CSP) system, comprising:
(a) a core of silica sand; and
(b) a coating layer composed of iron oxide and aluminum oxide coated on the core.

2. The thermal transfer media of claim 1, wherein the iron oxide is 8 to 12 parts by weight and aluminum oxide is 1 to 3 parts by weight based on 1000 parts by weight of the silica sand.

3. The thermal transfer media of claim 1, wherein the iron oxide is Fe₂O₃ and the coating layer has a hercynite structure represented by formula of AlFe₂O₃.

4. The thermal transfer media of claim 1, wherein bulk density and true density of the thermal transfer media is 0.5 to 2.5 g/cm³ and 1.5 to 4.0 g/cm³, respectively.

5. The thermal transfer media of claim 1, wherein particle size of the of the thermal transfer media is 100 to 1000 μm.

6. A method of preparing a thermal transfer media for a concentrating solar power (CSP) system of claim 1, which comprises:
(a) preparing a slurry by mixing silica sand and a dispersion liquid containing iron oxide and aluminum oxide;
(b) preparing coated particles by post-mixing the slurry; and
(c) sintering the particles under a forming gas environment with hydrogen at 300 to 500° C. and under argon gas environment at temperature of 900 to 1400° C., thereby inducing the formation of a hercynite structure.

7. The method of preparing a thermal transfer media of claim 6, wherein in step (a), the silica sand is prepared by performing acid-washing at pH 3-5.

8. The method of preparing a thermal transfer media of claim 6, wherein in step (a), the dispersion liquid containing iron oxide and aluminum oxide is prepared by dispersing in deionized water at pH 3-5 and ultrasonicating at room temperature for 5 to 15 minutes.

9. The method of preparing a thermal transfer media of claim 6, further comprising drying the slurry after step (a).

10. The method of preparing a thermal transfer media of claim 6, wherein step (b) is performed at room temperature for 1 to 3 days with 20-50% of relative humidity.

11. The method of preparing a thermal transfer media of claim 6, wherein step (c) comprises:
(i) placing the coated particles in a furnace pre-purged with forming gas;
(ii) raising a temperature to at 300 to 500° C. at a rate of 8 to 12° C. per minute;
(iii) maintaining in a forming gas atmosphere with 5% hydrogen followed by a higher-temperature phase with a rate of 3 to 7° C. per minute in an argon atmosphere to prevent oxidation; and
(iv) cooling the furnace at a rate under argon at 3 to 7° C. per minute.

12. The method of preparing a thermal transfer media of claim 6, wherein the temperature under argon gas environment is 1050° C.
